(19) United States
(12) Patent Application Publication
(10) Pub. No.: US 2015/0030027 A1
(43) Pub. Date: Jan. 29, 2015

(54) Switch Device With Device-Specified Bridge Domains

(71) Applicant: LSI Corporation, San Jose, CA (US)

(72) Inventors: Joseph A. Manzella, Macungie, PA (US); Nilesh S. Vora, Fogelsville, PA (US); Zhong Guo, Bethlehem, PA (US)

(73) Assignee: LSI Corporation, San Jose, CA (US)

(21) Appl. No.: 13/955,446

(22) Filed: Jul. 31, 2013

Related U.S. Application Data
(60) Provisional application No. 61/858,855, filed on Jul. 26, 2013.

(51) Int. Cl. H04L 12/713

(52) U.S. Cl. CPC H04L 45/586
USPC 370/392

(57) ABSTRACT

A switch includes registers, a parser and port selection logic. The registers store an address in multiple locations. The address defines a bridge domain. Each bridge domain defines a set of switch ports. The parser identifies when a received frame includes a virtual local area network (VLAN) identifier. The parser uses the VLAN identifier to locate the address in the registers. The port selection logic is responsive to one of a first index from a first table that includes port identifiers and the bridge domain and a second index from a second table that includes VLAN identifiers. The switch is configured by defining an address scheme, inserting an address field in the first and second tables, and generating maps from the tables. The maps direct the port selection logic to direct received frames to desired port(s).

### CROSS-REFERENCE TO RELATED APPLICATIONS

This patent application claims priority under 35 U.S.C. §119(e) to U.S. Provisional Patent Application Ser. No. 61/858,855, filed on Jul. 26, 2013, entitled, “Switch Device With Device-Specified Bridge Domains,” the entire contents of which are hereby incorporated by reference.

### TECHNICAL FIELD

The invention relates generally to devices that link network segments or network coupled devices.

### BACKGROUND

Packet-switched network describes a type of communication network in which relatively small units of data called packets are routed through a network based on the destination address contained within each packet. The division of data into packets allows the same data path to be shared among many users in the network. This type of communication between sender and receiver is known as connectionless (rather than dedicated). Most data traffic over the public access computer networks known as the Internet uses packet switching.

Ethernet is a packet-switched transmission protocol that is primarily used in local area networks (LANs). Ethernet is the common name of the Institute of Electrical and Electronic Engineers (IEEE) 802.3 industry specification in which packet-switched data is transmitted in frames. An Ethernet frame is illustrated in FIG. 1. To synchronize receiving nodes, each Ethernet frame 10 includes a 56-bit preamble 11 and an eight-bit start of frame delimiter 12. A destination address 13, a source address 14, and in some circumstances one or more virtual LAN identifiers 15 follow the preamble. A type/length identifier precedes a media access control (MAC) data 17 and a packet assembler/disassembler (PAD) 18 that vary in length from 46 to 1500 octets. A frame check sequence 18 adds four more octets. The frame size is determined from the start of the destination address 13 to the end of the frame check sequence 18 and thus may vary from 64 octets to 1518 octets. A number of network device manufacturers provide equipment that processes frames having a payload capacity that exceeds the IEEE 802.3 standard which mandates support for 46 to 1500-byte payloads.

As described in IEEE 802.3 a typical Ethernet source address 14 and destination address 13 are defined by a respective MAC address. As indicated in FIG. 2, the MAC address 23, 24 includes an I/G field 26 that indicates whether the address is an individual or a group address. A zero in this field identifies an individual address, while a one indicates a group address or multicast. A source address 14 will always include a zero in the I/G field 26. A U/L field 27 further indicates whether the address is a universal or local address. A zero in this field identifies a universally administered address, while a one indicates a locally administered address. A destination address 13 with all ones represents a broadcast address. The MAC address 23, 24 is completed with the address information or address bits 28.

FIG. 3 is an illustration of a unique MAC address 30, as presented in the IEEE standard 802-1990. An organizationally unique identifier (OUI) 31 is assigned to each global MAC address in an attempt to ensure uniqueness. The OUI 31 is a 3-octet hexadecimal representation that is applied in the first half of a 6-octet MAC address 23, 24. An organization (e.g., a manufacturer of network interfaces) using a given OUI 31 is responsible for ensuring uniqueness of the MAC address 23, 24 by (FIG. 2) assigning each produced unit its own unique 3-octet second-half address or unit unique information (UUI) 32.

FIG. 4 is an illustration of a locally administered MAC address 40. IEEE standard 802.3 indicates that the LSBs of the first transmitted octet should be “1” and “0” to indicate that the address is locally administered and a unicast address, respectively. However, IEEE standard 802.3 fails to disclose a method of ensuring unique MAC addresses for each port in an Ethernet-based packet-switching device.

International Patent Application No. PCT/SE2004/000055, as published in International Publication Number WO 2004/066589 A1, illustrates a method of ensuring unique MAC addresses in an Ethernet network. An access node uses a mapping function to map each original MAC address to one of a plurality of locally administered virtual MAC addresses and vice/versa. The method uses the six most significant bits of the first octet of the virtual address to define a domain for the address. A second portion of the virtual address indicates that the virtual address is locally administered. A third portion of the virtual address indicates a unit-specific use. A fourth portion of the virtual address includes an organizationally assigned unit-unique MAC address. For reasons that will become clearer, reliance on an organizationally assigned unit-unique MAC address are problematic.

A network switch is a communication device that receives data from any device connected to the network switch (i.e., a source) and transmits the data to one or more destination devices connected to the network switch. A network switch momentarily connects the sending and receiving devices so that they can transmit and receive data over the entire bandwidth of the network absent interference.

A switch operates at the data link layer of the open systems interconnection (OSI) model to create a separate collision free domain for each port. For example, when a computer is connected to a port of a switch, the computer has a dedicated point-to-point connection to the switch. Pairs of twisted conductors connect the switch to the computer. A first pair of conductors is used for receiving data packets from the switch. A second pair of conductors is used for transmitting packets to the switch. Some variations of Ethernet will use additional pairs of twisted conductors. For example, two pairs can be used to receive data packets from the switch and two pairs can be used to send data packets to the switch.

Once a packet transmitted from the computer reaches the switch to which it is directly connected via the dedicated twisted pairs of an Ethernet cable, its path to a destination device is managed by Ethernet Layer 2 and/or Ethernet Layer 3 switching protocols.

Ethernet Layer 2 (L2) switching allows frames to be switched in the network based on their MAC address or filtered based on the optional VLAN identifier 15. When a frame arrives at the switch, the switch checks the frame's destination MAC address 13 and, if known, sends the frame to the output port(s) associated with MAC address 13. In the same way that Internet protocol (IP) routing references stations on the Internet via a Layer 3 (L3) IP address, Ethernet L2 switching references end stations via the MAC address associated with a port.

Ethernet is a broadcast medium. Absent the concept of VLANs, a broadcast sent by a station on the LAN is sent to all physical segments of the switched LAN. The VLAN concept allows the segmentation of the LAN into logical entities, and traffic is localized within those logical entities. For example, a university campus may be allocated multiple VLANs with one dedicated for faculty, another dedicated for students, and the third dedicated for guests. Broadcast traffic within each of these VLANs is isolated to that VLAN.

A network bridge, also operating at the data link layer, interconnects two or more LANs, or two or more segments of the same network. In addition to connecting networks, a network bridge performs the additional function of filtering network traffic so that traffic intended for one portion of the network does not get placed on other portions of the network. Both switches and bridges record the MAC address of each device connected to the various ports of the bridge or the switch.

Devices on a network monitor network traffic and search for their own MAC address in each frame to determine whether they should decode the information in the frame. Special circumstances exist for broadcasting to every device on the network. Although some types of network devices, such as network interface cards (NICs), typically have a single MAC address, other types of network devices, such as routers, bridges, and switches, may have multiple MAC addresses. Network devices with multiple MAC addresses typically have a MAC address for each port on the network device.

A bridge domain is identified by a layer 2 forwarding database that contains MAC addresses recorded from packets received on the ports of the network device. This one-to-one relationship between a port and a MAC address in conventional network devices can be limiting. These limitations are not resolved by the virtual MAC address mapping described in WO 2004/066589.

For example, when a network device includes ports with different functions and the separate functions include network traffic designated for a first group (associated with a first set of ports), network traffic designated for a second group (associated with a second set of ports) different from the first group and network traffic designated for both groups, it may not be possible to ensure that there is a unique local address between the first and second groups. For example, this may be the case when MAC addresses are assigned or overwritten after the devices have been coupled to the network. Accordingly, it may be the case that network traffic destinations cannot be resolved and/or that network traffic is improperly broadcast on the network.

### SUMMARY

Embodiments of a device and method for enabling a dual Layer 3-Layer 2 device to implement separate device-specified domains are illustrated and described in exemplary embodiments. Improved devices consistent with the inventive concept include devices with a data table that support independent address schemes. These new address schemes can define local traffic groups and a global or device-wide traffic group which can be used in an environment in which the improved device is coupled to external devices that share the same local MAC address. The new address scheme is added to tables and maps that are searched by a lookup key engine. The new address scheme includes information that identifies the local traffic group that a source device is targeting. The improved device uses the information in the new address scheme to alleviate the otherwise inevitable collision when the improved device or switch is coupled to external devices that share the same local MAC address. In some embodiments, the independent address spaces may overlap. That is, one or more local addresses may be included in otherwise separate device-specified domains. A combination of the device-specified domain and a MAC address may be used to deliver network traffic to unique devices.

In an exemplary embodiment, a switch includes a set of registers, a parser or parsing logic, and port selection logic arranged with a desired number of input/output interfaces (or MAC logic circuits) and physical conductors supporting ports. The registers are coupled directly or indirectly to the parsing logic and port selection logic. The registers store an address other than a MAC address. In accordance with an address scheme, the contents of the address identify a bridge domain. Each bridge domain includes a set of ports. The parsing logic identifies when the header of a received frame includes a VLAN identifier. When present, the parsing logic uses the VLAN identifier to locate the address in the set of registers. The port selection logic is responsive to one of a first index from a first table or a second index from a second table. The tables are formed from a set of the registers. The first table includes port identifiers and the bridge domain. The second table includes VLAN identifiers.

In another exemplary embodiment, a method for enabling a switch to implement device-specified bridge domains is disclosed. The method includes the steps of defining an address scheme, inserting an address field responsive to the address scheme in a first table including a port identifier, inserting the address field responsive to the address scheme in a second table that includes both a port identifier and a VLAN identifier, generating a VLAN map from the second table and generating layer 2 and layer 3 maps from one or more of the first table, the second table and a third table separate from the first and second tables.

### BRIEF DESCRIPTION OF THE DRAWINGS

FIG. 1 is a schematic illustration of a conventional Ethernet frame.

FIG. 2 is a schematic illustration of a conventional MAC address of the Ethernet frame of FIG. 1.

FIG. 3 is a schematic illustration of a conventional globally administered unique MAC address.

FIG. 4 is a schematic illustration of a conventional locally administered MAC address.

FIG. 5 is a schematic illustration of an improved switch.

FIG. 6 is a block diagram illustrating an example embodiment of the switch of FIG. 5.

FIG. 7 is a flow diagram of an embodiment of a method for a switch that applies device-specified bridge domains to received data frames.

FIG. 8 is a schematic illustration of a device-specified bridge domain.

FIGS. 9A and 9B include a flow diagram illustrating an embodiment of a method for managing the distribution of received data frames.

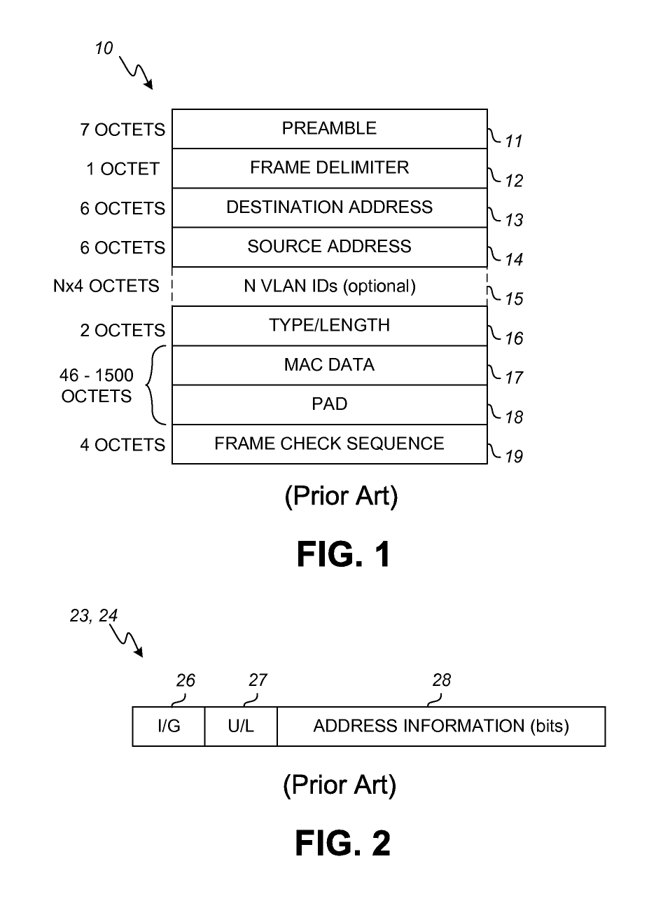

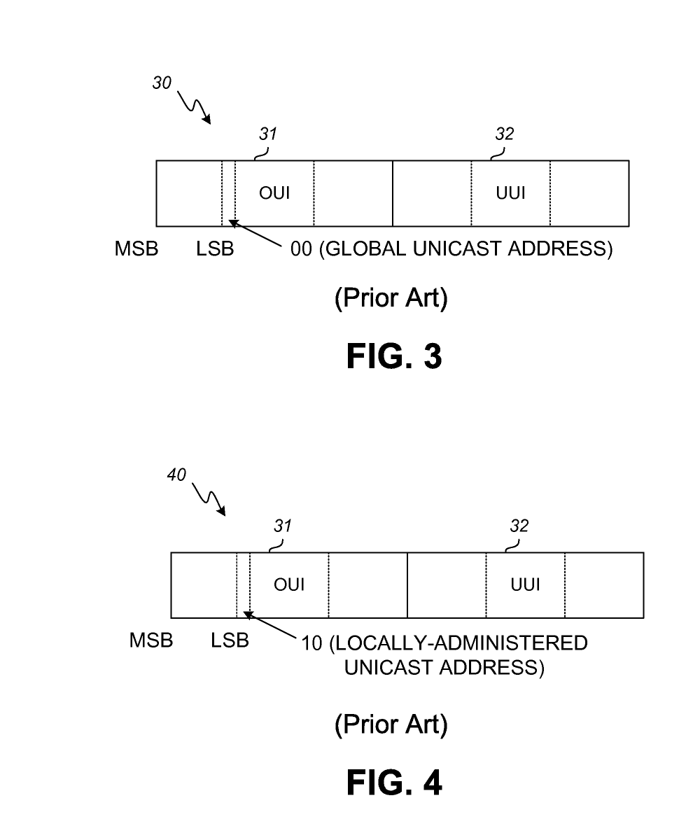

### DETAILED DESCRIPTION OF ILLUSTRATIVE EMBODIMENTS

A switch includes registers, parsing logic and port selection logic. The registers store an address in multiple locations within registers or collections of registers referred to as tables. The address defines a bridge domain. Each bridge domain defines a set of switch ports. The parsing logic identifies when a received frame includes a VLAN identifier. The parsing logic or parser uses the VLAN identifier to locate the address in the registers. The port selection logic is responsive to one of a first index from a first table that includes port identifiers and the bridge domain and a second index from a second table that includes VLAN identifiers. The switch is configured by defining an address scheme, inserting an address field in the first and second tables, and generating maps from the tables. The maps direct the port selection logic to direct received frames to desired port(s).

The improved switch is arranged with a bridge domain that identifies the traffic domain with which a source intends to communicate data. For purposes of illustration, a 2-bit address field identifies 4 bridge domains. However, it should be understood that the address space (i.e., size in bits) is not so limited. In some circumstances, such as those where a global domain or overlapping domains are not desired, a 1-bit address will suffice to identify two bridge domains. When more than 4 bridge domains are desired, the address space can be increased above 2, with 2^{N} domains being addressable for N-bits where N is an integer

In an example embodiment, a first table is analyzed using an index that includes a port identifier and a VLAN identifier. The lookup operation returns the bridge domain value and reports on the validity of the index. When the result of the lookup operation indicates that the port/VLAN index is invalid or that the received frame header is not VLAN tagged, a second table is analyzed using an index that includes a port identifier and an Ethernet type. The Ethernet type may be determined directly or indirectly from information in the frame header. The lookup operation returns the bridge domain value and reports on the validity of the index. When either lookup returns both a bridge domain and an indication that the associated index is valid, the bridge domain value is sent to the bridging layer where layer-2 and layer-3 information is used in conjunction with the bridge domain to appropriately distribute received Ethernet frames.

The bridging layer execution is relatively straightforward. The bridge domain information from the parsing logic is used for both the look up and when MAC address learning is required (i.e., when a new device is coupled to the switch). The bridge domain information or address is appended onto the key that is used during the look up operation.

A masking procedure responsive to the bridge domain information or address can be added in multiple locations. For example, a mask responsive to the bridge domain can be applied to a learning process to reduce the time it takes the improved switch to discover or distinctly identify one or more new MAC addresses when devices are connected to the switch. By way of further example, a mask responsive to the bridge domain can be applied in the port selection logic. Such a mask can be global (i.e., applied equally to each bridge domain). Alternatively, a separate mask can be applied to each domain. However enabled, the bridge domain can be used to ensure that an Ethernet frame does not get routed to a network-coupled device belonging in another domain.

In operation, an improved switch behaves as if it has multiple device-specified bridge domains. Accordingly, a MAC address can be used in several different places, while conserving hardware and providing sufficient isolation as appropriate. For example, when multiple ports are associated with devices with different functions, an address scheme can be devised to separate the ports into distinct traffic groups. A first traffic group may be defined by a first set of switch ports. A second traffic group may be defined by a second set of switch ports. A third traffic group may include global traffic or traffic intended for switch ports of both the first traffic group and the second traffic group. When a port in the first traffic group includes a MAC address that is also found in the second traffic group, the bridge domain information stored in a port/bridge domain table and/or in a VLAN table contains an indication of the port and/or ports that the source address intends to send the data to, which alleviates the otherwise inevitable collision if only MAC addresses are used to identify destination targets.

In addition, the bridging information can be used to provide different capabilities for each domain. For example, policy based routing tables can be generated to forward or filter traffic based on a combination of the bridge address and one or more of frame size, protocol of the payload, or other information from the header or the frame payload. Similarly, alternative sets of tables can be generated to forward or filter traffic based on a combination of the bridge address and one or more of IP addresses and port numbers.

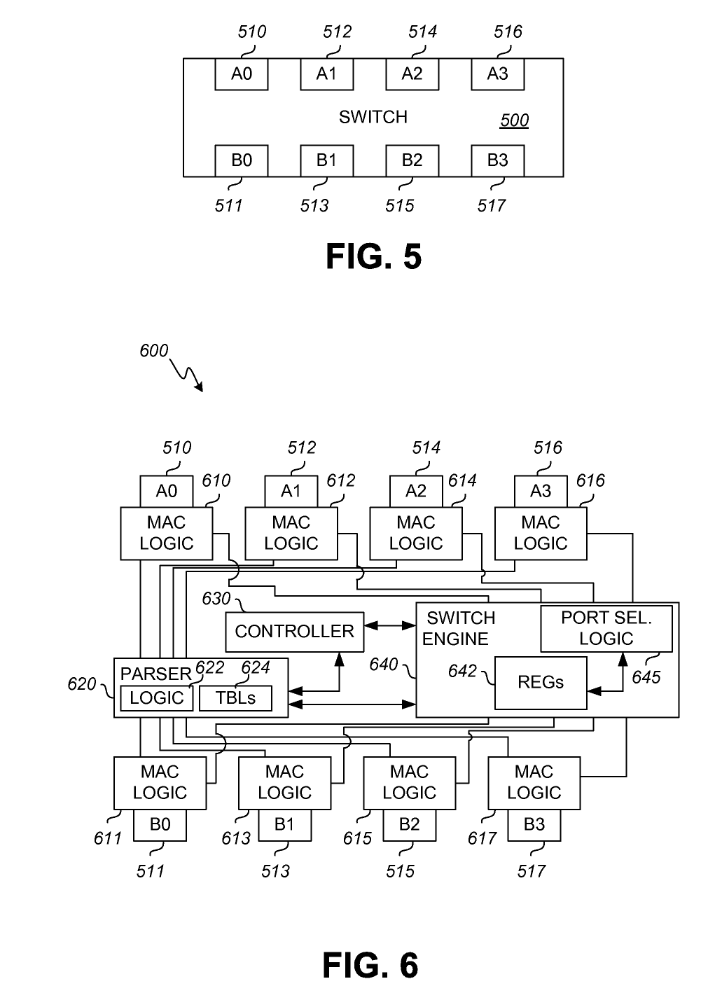

Attention is now directed to the illustrated embodiments of the improved switch as shown in FIGS. 5-9B. FIG. 5 is a schematic illustration of an 8-port switch 500. Although the example switch 500 is an 8-port switch, it should be understood that the principles disclosed herein can be applied to switches configured with any number of separately distinguishable ports.

As illustrated, the switch 500 is operationally divided into two traffic groups or bridge domains. A first set of ports are associated with traffic group A. The traffic group A ports include port A0 510, port A1 512, port A2 514 and port A3 516. A second set of ports are associated with traffic group B. The traffic group B ports include port B0 511, port B1 513, port B2 515 and port B3 517. Like the traffic group A ports (510, 512, 514, 516), the traffic group B ports (511, 513, 515, 517) are arranged to both receive and transmit data. All 8-ports receive and transmit data in accordance with IEEE standard 802.3 or in accordance with later developed packet-switching protocols. For example, an 8P8C modular connector, often known as a RJ45 connector, (not shown in FIG. 5) is commonly used on category 5/5e cables to connect external devices to one another via ports 510-517 of switch 500. Although illustrated and described in the example embodiment as being sub-divided into two traffic groups with each having a similar number of ports, any number of alternative arrangements for sub-dividing or identifying traffic groups is contemplated.

For any number of reasons it may be desired to isolate data traffic within traffic group A (ports A0-A3). Stated another way, data traffic received on any one of ports A0-A3 should only be forwarded to other ports within traffic group A. Similarly, it may be desirable to isolate data traffic within traffic group B (ports B0-B3). That is, data traffic received on any one of ports B0-B3 should only be forwarded to other ports within traffic group B. As indicated, this is conventionally accomplished by identifying globally unique MAC addresses associated in a one-to-one relationship with the source and destination devices. However, when MAC addresses are reused they are no longer unique and it is no longer possible to avoid collisions. Stated another way, absent the association with a traffic group and a desire to isolate traffic to ports in that traffic group it would be impossible to distinguish or identify a single destination port when ports A1 and B3 had the same MAC address.

FIG. 8 is a schematic illustration of an embodiment of an example device-specified bridge domain. In the example, a 2-bit address space 810 is used to associate a designated two-bit sequence with 3 identified traffic groups. As shown, bit sequence “10” is associated with traffic group A, which includes ports A0-A3. Similarly, bit sequence “01” is associated with traffic group B, which includes ports B0-B3. Thus, the first domain and the second domain are respectively associated with different sets of ports on the switch 500. As further indicated in FIG. 8, bit sequence “00” is associated with all ports of the switch 500. Accordingly, a third domain identifies a set of ports that include at least one member from the first set of ports and at least one member from the second set of ports. While the example embodiment includes a third traffic group that includes the union of all members (i.e., ports) of the first and second traffic groups, other embodiments may include an alternative traffic group that excludes one or more members of one or more of the remaining traffic groups as may be desired.

In the example address scheme the bit sequence “11” is invalid. However, it should be understood that in alternative embodiments the bit sequence or address “11” could be used to identify a set of ports comprising some but not all the member ports from traffic groups A and B to identify a separate and distinct traffic group C. As the number of desired bridge domains increases above 2^{N} it will be necessary to increase the size of the address space by a bit to uniquely associate a particular bit sequence with a specified domain. For example, a 3-bit address space can be used to identify up to 8 separate domains.

FIG. 6 is a block diagram illustrating an example embodiment of the switch of FIG. 5. The switch 600 is arranged with 8 ports and further includes a parser 620, a controller 630 and a switch engine 640. Each of the traffic group A ports (510, 512, 514, 516) and the traffic group B ports (511, 513, 515, 517) are coupled to both the parser 620 and the switch engine 640 via a respective MAC logic circuit.

Each MAC logic circuit includes MAC logic suitable for communicatively coupling electrical signals received by or intended to be transmitted by a corresponding port and one or more switch circuits. In some arrangements, the MAC logic circuit includes or is coupled to a serializer/deserializer circuit commonly referred to as a SERDES. In alternative arrangements, the MAC logic circuit(s) may include or are coupled to one or more I/O buffers or I/O interfaces other than a SERDES.

The controller 630 provides one or more clock signals, timers, firmware storage and embedded logic (not shown) for coordinating the receipt, identification, and processing of Ethernet frames through the switch 600. For example, port A0 510 is coupled to the parser 620 and the switch engine 640 by MAC logic circuit 610. Port A1 512, port A2 514, and port A3 516 are similarly coupled by MAC logic circuit 612, MAC logic circuit 614 and MAC logic circuit 616, respectively. In addition, port B0 511 is coupled to the parser 620 and the switch engine 640 by MAC logic circuit 611. Port B1 513, port B2 515, and port B3 517 are similarly coupled by MAC logic circuit 613, MAC logic circuit 615 and MAC logic circuit 617, respectively.

All 8-ports receive and transmit data. These data transfers can be accomplished in accordance with IEEE standard 802.3, which supports coordinated data transfers from about 1 Mbit/s to about 100 Gbits/s over a number of different physical media (e.g., coaxial cable, cables with shielded conductors arranged in shielded twisted-pairs, single and multiple-mode optical fiber. In addition, the ports 510-517 working in conjunction with MAC logic circuits 610-617 will support multiple data transfer rates, using auto-negotiation with an external connected device to identify the best rate supported by both network-coupled devices.

The parser 620, functioning in accordance with one or more clock and timer signals provided by the controller 630, is arranged with logic 622 and one or more tables 624 that are referred to by the logic 622 to separate and forward specific bits in each incoming frame header. This “parsed” or separated information is forwarded to direct the switch engine 640 in how to process (e.g., route, drop) the corresponding Ethernet frame. For example, the parser 620 uses the frame delimiter 12 as a guide in identifying a destination address 13, source address 14, type/length identifier 16, MAC data 17, PAD data 18, and frame check sequence 19. In addition, the parser 620 will separate and forward the contents of the I/G field 26 to indicate to the switching engine 640 whether the address is an individual or group address. The parser 620 will also separate and forward the contents of the U/L field 27 to indicate to the switching engine 640 whether the address is a universal or locally administered address.

The parser 620 is further configured to determine when the header of a received Ethernet frame includes one or more VLAN identifier(s) 15. When the VLAN identifier(s) 15 is/are present, the parser 620 uses a VLAN identifier 15 to locate an index in a first table supported by the registers 642. Otherwise, when the VLAN identifier 15 is not present, the parser 620 uses an Ethernet type and a destination port to locate the address in a second table implemented in the registers 642. In some arrangements, the internal tables 624 of the parser 620, which consist of registers as well, will be consulted to determine an appropriate destination port or ports.

The parser 620 is also configured to perform a check of the Ethernet frame to identify when transmission errors may have occurred or to check for any number of additional reasons not to forward received information. For example, when malformed or unidentifiable packets are received). When the parser 620 identifies the presence of transmission errors, the parser 620 sets a flag or other indicator that indicates that the information in the received frame is invalid. When such is the case, the Ethernet frame is marked to be discarded rather than forwarded to the switch engine 640 to perform the layer 2 bridging or layer 3 routing. The parser 620 may be further responsive to other discard conditions, such as those based on one or more of frame length, Ethernet type, VLAN identifier validity, or protocol and under some conditions may be arranged to store a discarded frame in a log for debug purposes.

Although illustrated and described as a single entity, it should be understood that the parser 620 and its various functions may be implemented in a distributed manner with one or more additional parsers or other circuit arrangements capable of performing one or more the described functions located in more than a single location on the switch 600. In some arrangements, a parser 620 and/or parsing logic 622 can be arranged to support multiple ports. When so arranged, such a multiple port parser may share a table or tables to support the shared functions.

The switch engine 640 includes registers 642 and port selection logic 645. The registers 642 are hardware data storage elements. The registers 642 are arranged in tables that when accessed with a search index forward a match location of the word or data item in the select table that matches the information in the search index. The registers 642 may comprise an array of bi-stable flip-flops, which will retain a data value as long as the switch 600 provides power to the switch engine 640. As will be described in greater detail, the registers 642 will be arranged in a VLAN index table, a port index table, and a hybrid index table that includes both port and VLAN indexes. The N-bit domain information is added to the port index table and the hybrid index table. Accordingly, even when a network includes shared MAC addresses (no matter how that unintended situation was introduced) the domain identifier can be used in conjunction with access control rules or in conjunction policy based rules to appropriately identify a unique destination within a network.

The port selection logic 645 is arranged to direct the transfer of received Ethernet frames to a select port or ports of the switch 600. The port selection logic 645 is responsive to one or more maps that function in conjunction with the words or results from the tables. As described, the results are determined from a mask or map entry identified by one of the first index or the second index.

For example, the port selection logic 645 may identify a port for forwarding a received Ethernet frame in accordance with a protocol map that includes access control rules that are applied to ports and/or IP addresses. By way of further example, the port selection logic 645 may identify a port or ports for forwarding a received Ethernet frame in accordance with policies defined by a network administrator. These policies may direct Ethernet traffic based on the source or destination port, protocol, payload length in octets, service class, among others.

The switch engine 640 is arranged with a bridge protocol data unit (BPDU) and other circuits that receive information from the parser 620 responsive to the header and the payload of all received Ethernet frames. When the switch engine 640 receives BPDU data packets from other switches in the LAN containing information on ports, addresses, priorities and costs, the switch engine 640, operating in accordance with a spanning tree algorithm in the bridging layer, exchanges messages and deploys a spanning tree protocol to detect loops or redundant paths in the LAN in which the switch 600 is deployed. The switch engine 640 is configured with logic circuits that use the information in the spanning tree topology to shut down select bridge interfaces (i.e., the switch engine 640 will prevent the transfer of Ethernet frames to a blocked port).

In one embodiment, the functional blocks represented in switch 600 are implemented in an application specific integrated circuit (ASIC). Those skilled in the art of developing system-on-chip (SoC) designs are familiar with formats for describing the functionality of an integrated circuit or modular block within a larger integrated circuit system via mechanisms such as register transfer logic (RTL). In addition, those skilled in the art of developing SoC designs can create RTL-level designs that can be analyzed with various software diagnostic tools to verify intended operation of the SoC under various environmental conditions. Accordingly, one can use the principles discussed above in a system with a processor and a memory in a virtual implementation to avoid collisions in a virtual switch. In these virtual embodiments, a data store will include manifestations of the above-described tables in one or more programmable memory devices. When so embodied, the tables and one or more of the parser, controller and switch engine may be stored on a computer-readable medium. When so stored, the underlying logic that enables the functionality associated with each of the parser, controller and switch engine is present in a non-transitory form (e.g., as a set of stored executable instructions, RTL or pseudo code that can be accessed and executed by a processor to perform an intended function).

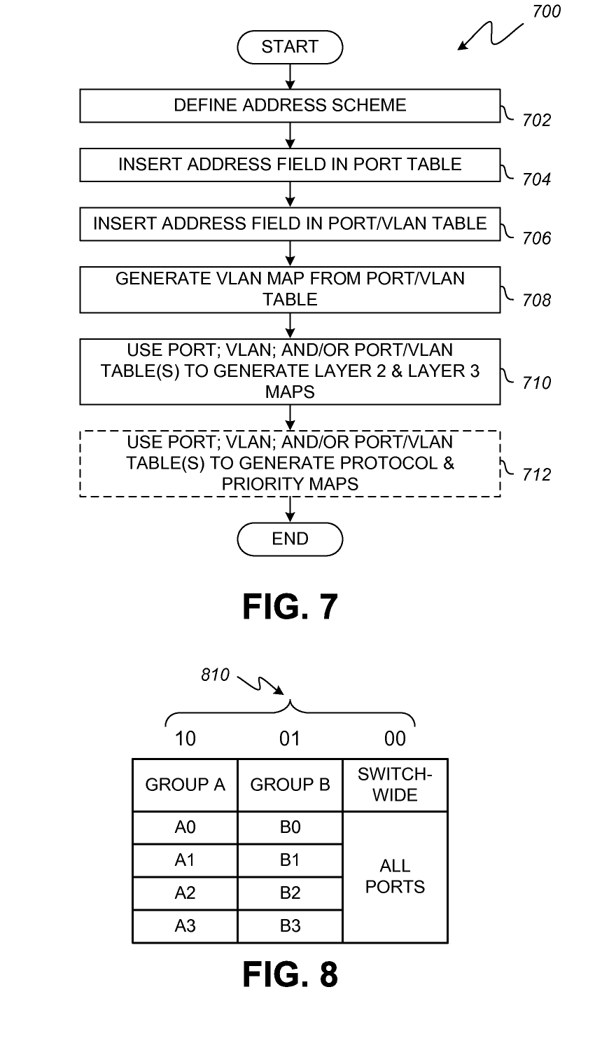

FIG. 7 is a flow diagram of an embodiment of a method 700 for configuring a switch 500 or switch 600 that applies device-specified bridge domains to received Ethernet data frames. The method 700 begins with block 702 where an address scheme is defined. As indicated, an address scheme will include an association between an N-bit address and a traffic group. As also indicated, the traffic groups may be separate and distinct from one another (i.e., include ports that are only members of a single distinct group) or one or more traffic groups may include one or more members from other traffic groups as may be desired. Once the address scheme is defined, address fields are inserted in a port table as indicated in block 704 and in a port/VLAN table as indicated in block 706. Thereafter, as shown in block 708, a VLAN map is generated from the port/VLAN table. As shown in block 710, layer-2 and layer 3 maps are generated from one or more of the port, VLAN, and/or the port/VLAN tables. As further shown in block 712 one or more of the port, VLAN, and/or the port/VLAN tables are used to generate protocol and priority driven maps.

Those skilled in switching architectures will understand that the layer 3 maps will include both source and destination Internet protocol (IP) addresses as well as source and destination terminal control protocol addresses, while the layer 2 maps will include source and destination MAC addresses as well as protocol and priority information identified by one or more of an Ethernet type, Ethernet protocol (including dynamic subnet configuration protocol), or class of service.

A priority specific map is generated from a combination of one or more of the first table, the second table and the third table and one or more of a class of service (COS) or information responsive to a dynamic subnet configuration protocol identified in a priority table.

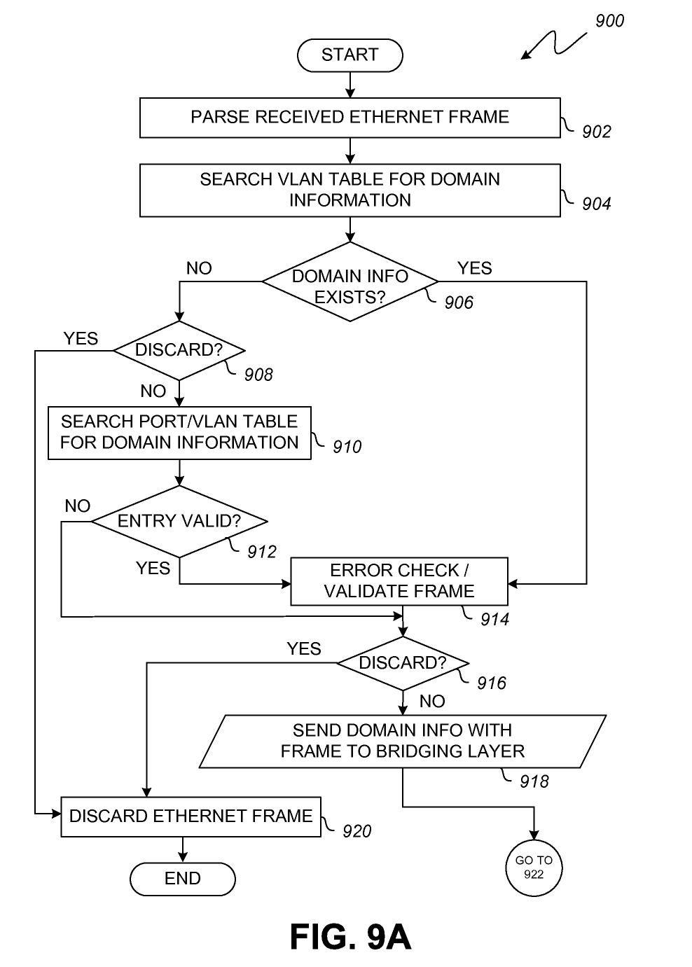

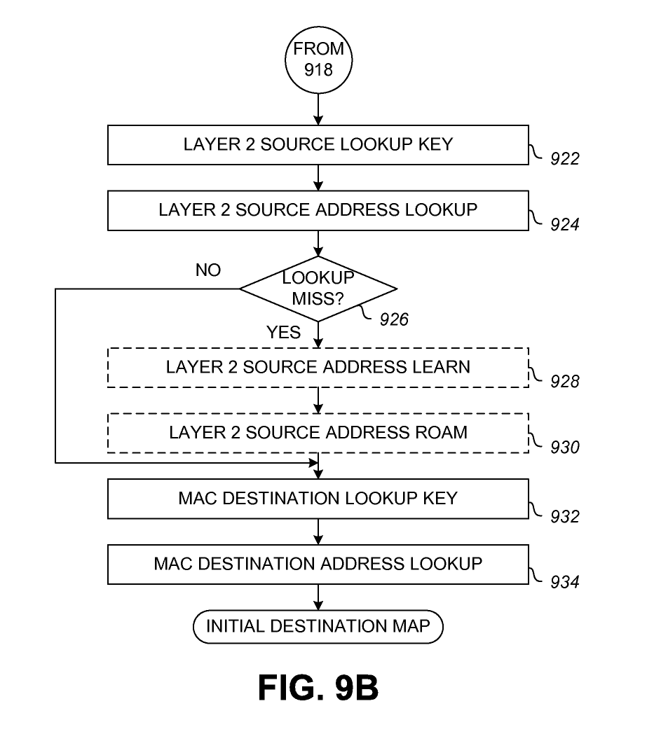

FIGS. 9A and 9B include a flow diagram illustrating an embodiment of a method for managing the distribution of received Ethernet frames. Method 900, which can be implemented by the switch 600 of FIG. 6 and/or a virtual switch, begins with block 902 where an Ethernet frame is parsed to identify the various components of the Ethernet header and payload. In some embodiments, the received Ethernet frame header is first checked to determine if it includes a VLAN identifier. When the frame is VLAN tagged, processing will check the VLAN table for domain information as shown in block 904. When domain information is present in the VLAN table, the domain information will be forwarded from that location later in the method to support MAC address learning and or bridging. Otherwise, when the VLAN identifier is not present in the received frame header, processing will continue with block 910 where a port table is searched for domain information associated with an Ethernet type. When the VLAN table includes domain information, as indicated by the flow control arrow labeled “YES,” exiting decision block 906, processing continues with an error check and/or conformity verification of the received Ethernet frame, as indicated in block 914. Otherwise, as indicated by the flow control arrow labeled “NO,” exiting decision block 906, a determination is performed as indicated in decision block 908, whether to discard the Ethernet frame. If a discard condition exists, e.g., when it is determined that the VLAN identifier is invalid, as indicated by the flow control arrow labeled, “YES” exiting decision block 908, or any other desired verification of the frame has failed an appropriate test, processing continues with block 920 where the Ethernet frame is discarded. A discarded frame will not be forwarded to a destination port or ports. In some embodiments and under certain conditions, a discarded frame or a portion thereof may be stored in a programmable memory element accessible with the controller 630 for diagnostic analysis and reporting.

When a discard condition is not identified, as indicated by the flow control arrow labeled “NO,” exiting decision block 908, processing continues with block 910 where a port/VLAN table located in the registers 642 is searched for domain information. As indicated, the port/VLAN table search locates domain information associated with a port and an Ethernet data type (e.g., IP, VLAN, Novell IPX, address resolution protocol (ARP)). When the entry in the port/VLAN table is valid, as indicated by the flow control arrow labeled “YES,” exiting decision block 912, processing continues with block 914, where an error check is performed. If a discard condition exists, i.e., there is likely an error in the Ethernet frame, as indicated by the flow control arrow labeled “YES,” exiting decision block 916, processing continues with block 920 where the Ethernet frame is discarded.

When a discard condition is not identified, as indicated by the flow control arrow labeled “NO,” exiting decision block 916, processing continues with input/output block 918, where the VLAN identifier, domain information and Ethernet frame are forwarded to the port selection logic 645 for bridge layer processing.

As indicated by the flow diagram connector, processing continues with block 922 of FIG. 9B where a layer 2 source lookup key is generated. As a part of this process, the domain identifier consistent with a defined address scheme is inserted in or concatenated with the MAC source lookup key. In block 924, the source lookup key is used to perform a source address lookup. The source address lookup may include a sub-step that appends a VLAN identifier to the MAC address to generate an address that can use the same MAC address across multiple VLANs. This alternative sub-step is performed when independent VLAN learning (IVL) is desired as indicated by information in the Ethernet header. The source address lookup uses a key that includes the domain information received from the parser 620. Thereafter the internal address table is searched. When a match is detected in a layer 2 source address lookup, as indicated by the flow control arrow labeled “NO,” exiting decision block 926, processing continues with block 932. Otherwise, when the layer 2 source address lookup indicates that the source address is not already known, i.e., a lookup miss occurred, a number of parameters are set to predetermined or default values to prime or configure the same for use in an optional learn address procedure.

As indicated and when so enabled, processing continues with block 928 where a layer 2 source address learn procedure is performed. Learning may be enabled or disabled based on attributes such as the input port, key type, or one or more configuration parameters stored in associated registers. If enabled, as MAC addresses are identified with ports, the information is added to a source address table. As shown in block 930, the source address learn is followed with a layer 2 source address roam process. The roam process identifies when a MAC address has moved from a first port to a second port. This can occur as a mobile device is moved about an office or campus as the device moves out of the radio range of a first wireless access point and into the range of a second wireless access point.

Once the layer 2 source address learning and roaming have completed, processing continues with block 932 where a MAC address destination lookup key procedure is performed. As a part of this process, the domain identifier consistent with a defined address scheme is inserted in or concatenated with the MAC destination lookup key. When the Ethernet frame header indicates that multiprotocol label switching (MPLS) is to be performed, the key will include the domain information and the MPLS label. When the Ethernet frame header indicates that customer or service tags are present, these tags will be included with the domain information when constructing the destination lookup key. Similarly, if IVL is desired, the lookup key is constructed as a combination of the domain information, the MAC address and the VLAN identifier. However constructed, the key is then used in MAC destination address lookup operation, as indicated in block 934. Keys may also be constructed using other combinations of fields, which provide source and/or destination ports as desired. Thereafter, the switch generates a destination map.

The flow diagrams of FIGS. 9A and 9B are intended only to be exemplary or illustrative of the logic underlying the described method. Persons skilled in the art will understand that in various embodiments, both physical devices (e.g., hardware systems, application specific integrated circuits (ASICs) and/or virtual switches (e.g., a switch enabled through the execution of programmable instructions coupled with stored data) can be arranged or configured in any of various ways to effect the described methods. It should further be appreciated that to support hundreds of millions of packets each second, a hardware implementation on an ASIC is considered and preferable over a virtual switch enabled by a general purpose processor coupled to one or more accessible memory elements for storing the various tables and logic instructions. The ASIC may be modeled in a simulator and tested to prove concept and design before committing resources to the processing of silicon.

In addition, it should be appreciated that the steps or acts described above can occur in any suitable order or sequence, including in parallel or asynchronously with each other. Steps or acts described above with regard to FIGS. 9A and 9B can be combined with others or omitted in some embodiments. Although depicted for purposes of clarity in the form of a flow diagram in FIGS. 9A and 9B, the underlying logic can be modularized or otherwise arranged in any suitable manner. Persons skilled in the art will readily be capable of programming or configuring suitable software or suitable logic, such as in the form of an ASIC or similar device or a combination of integrated circuits or devices, to effect the above-described functions to perform the described methods. Also, it should be understood that the combination of a domain scheme (i.e., data), coupled with a defined switch environment and software instructions or similar logic can be stored in a non-transitory computer-readable medium.

Later enabled communication protocols are likely to exceed the above described data transfer rates such as those associated with IEEE standard 802.3. That is, one or more future standards for communicating data between devices is likely to achieve data transfer rates that exceed 100 Gbits/s. It should be understood that the principles described herein for defining specified domains in a switch are not limited by ports and MAC logic circuits capable of supporting any specific range of data transfer rates.

It should be noted that the improved switch has been described with reference to one or more exemplary embodiments for the purpose of demonstrating novel principles and concepts. The improved switch is not limited to these embodiments. As will be understood by persons skilled in the art, in view of the description provided herein, many variations may be made to the embodiments described herein and all such variations are within the scope of the switch and methods for configuring the same as defined in the claims.

What is claimed is:

1. A switch, comprising:
a set of registers storing an address other than a media access control address, the contents of the address identifying a bridge domain;
a parser coupled to the set of registers and arranged to identify when a header of a received Ethernet frame includes a virtual local area network (VLAN) identifier, the parser arranged to use the VLAN identifier to locate the address in the set of registers; and
port selection logic coupled to the set of registers and responsive to one of a first index from a first table that includes port identifiers and the bridge domain and a second index from a second table that includes VLAN identifiers.

2. The switch of claim 1, wherein the address comprises N bits enabling the definition of 2^{N} different domains.

3. The switch of claim 2, wherein N is an integer greater than or equal to two.

4. The switch of claim 1, wherein the bridge domain is associated with at least a first set of ports and a second set of ports different from the first set of ports.

5. The switch of claim 4, wherein the bridge domain is further associated with a third set of ports that include at least one member from the first set and at least one member from the second set.

6. The switch of claim 1, wherein the parser generates a lookup key including the bridge domain and media access control address information.

7. The switch of claim 1, wherein the port selection logic is responsive to a map entry identified by one of the first index or the second index.

8. The switch of claim 1, wherein when the header of the received Ethernet frame does not contain a VLAN identifier, the parser is arranged to use an Ethernet type to locate the address in the set of registers.

9. The switch of claim 1, wherein the parser is further arranged to perform a check of the Ethernet frame data to identify when transmission errors are present.

10. The switch of claim 9, wherein the parser is further arranged to disable learning.

11. The switch of claim 1, wherein the parser is further arranged to set a flag in response to one or more discard conditions.

12. The switch of claim 11, wherein the parser is arranged to store a discarded frame.

13. The switch of claim 1, wherein the parser is arranged to use the second index from the second table when a lookup of the first table fails.

14. The switch of claim 13, wherein the second index is identifies a destination port and an Ethernet-type match.

15. A method for enabling a switch to implement device-specified bridge domains, the method comprising:
defining an address scheme;
inserting an address field responsive to the address scheme in a first table including a port identifier;
inserting the address field responsive to the address scheme in a second table that includes both a port identifier and a virtual local area network (VLAN) identifier;
generating a VLAN map from the second table; and
generating layer 2 and layer 3 maps from one or more of the first table, the second table and a third table separate from the first table and the second table.

16. The method of claim 15, wherein the address scheme is defined by a N-bit address that enables 2^{N} different domains.

17. The method of claim 16, wherein the N-bit address defines at least a first set of ports and a second set of ports different from the first set of ports.

18. The method of claim 15, further comprising:
generating a lookup key including the device-specified bridge domain as identified by the address field and media access control address information.

19. The method of claim 15, further comprising:
generating a protocol specific map from a combination of one or more first table, the second table and the third table and a port type identified in a port table.

20. The method of claim 15, further comprising:
generating a priority specific map from a combination of one or more of the first table, the second table and the third table and a class of service identified in a priority table.
